(19) United States
(12) Patent Application Publication
(10) Pub. No.: US 2019/0360711 A1
(43) Pub. Date: Nov. 28, 2019

(54) METHOD AND DEVICE FOR CONTROLLING POWER SUPPLY TO HEATING, VENTILATING, AND AIR-CONDITIONING (HVAC) SYSTEM FOR BUILDING BASED ON TARGET TEMPERATURE

(71) Applicant: SEOKYOUNG SYSTEMS, Seoul (KR)

(72) Inventors: YoungSeok SOHN, Seongnam-si (KR); SangDeok CHOI, Seongnam-si (KR); Youngjin KIM, Pohang-si (KR); Sungah KIM, Seoul (KR); Hwanjo YU, Pohang-si (KR); John Joonho PARK, Fort Lee, NJ (US)

(21) Appl. No.: 16/177,418

(22) Filed: Oct. 31, 2018

Related U.S. Application Data
(60) Provisional application No. 62/675,136, filed on May 22, 2018.

(51) Int. Cl. F24F 11/47; F24F 11/64; F24F 11/80; G05B 15/02

(52) U.S. Cl. CPC F24F 11/47; F24F 11/64; F24F 11/56; G05B 15/02; F24F 11/80

(57) ABSTRACT

The present disclosure provides a device for controlling power supply to a heating, ventilating, and air-conditioning (HVAC) system for a building based on a target temperature. The device comprises a memory and a processor connected to the memory, wherein the processor is configured for: generating a zone-based temperature prediction model by training an artificial neural network based on a plurality of first training data; and determining a sequence of optimal to-be-supplied powers at one or more time-points after a current time-point, wherein the sequence of optimal to-be-supplied powers allows minimizing a value of a loss function associated with a difference between a sequence of predetermined target temperatures and a sequence of predicted temperatures predicted based on the zone-based temperature prediction model.

### CROSS-REFERENCE TO RELATED APPLICATION

This application is based on and claims the benefit of priority to U.S. Provisional Patent Application No. 62/675,136, filed on May 22, 2018, the disclosure of which is incorporated herein in its entirety by reference.

### BACKGROUND OF THE INVENTION

### Field of the Invention

The present disclosure relates to a power supply control, and more particularly, to a method and device for controlling power supply to an HVAC (heating, ventilating, and air-conditioning) system for a building.

### Related Art

Generally, various types of heating, ventilating, and air conditioning (HVAC) system are utilized to regulate the environment of enclosed spaces within residential, commercial, and industrial buildings. The HVAC systems represent approximately 30% of electricity usage in a commercial building and are major drivers of summer and winter peak loads. Specifically, the majority of the electricity usage is used for a chiller, which commonly consists of an evaporator, a compressor, a condenser, and an expansion valve. The evaporator exchanges the heat between the air or water to be cooled and a refrigerant used as a working fluid. After the compressor raises the refrigerant temperature and pressure, the heat collected in both the evaporator and the compressor is removed from the refrigerant to the ambient air through the condenser. The chiller operates with air supply fans or water pumps that are used to distribute the cooling air or water, respectively, to multiple thermal zones.

The optimal operation of HVAC units has been widely studied particularly to reduce heating or cooling energy waste and improve the flexibility of building energy consumption. For the optimal operation, a model predictive control (MPC) approach was commonly adopted in previous studies to formulate optimal scheduling problems for energy usage minimization. However, the MPC approach requires comprehensive understanding of HVAC unit composition, as described above, and thermal dynamics of building environment: e.g., the heat transfer between the refrigerant, cooling air or water, and ambient air. The pressures inside air ducts and water pipes also need to be carefully taken into consideration. However, owing to computational complexity and a large number of required parameters, the dynamic models of the HVAC system and building environment were simplified, for example, with first-order approximation assumptions in the previous MPC methods. This results in non-negligible discrepancies between the scheduled and actual temperatures particularly in complex, large-scale buildings where multiple thermal zones exist and interact together. In practice, the optimal operating schedules of HVAC systems are often disregarded to fix the temperature errors and prevent occupant complaints. The issue on the waste of heating or cooling energy remains unsolved.

In addition, the optimization scheduling problems are formulated with the inequality constraints on the zone-based temperatures: e.g., T_{z,min}≤T_{z}(t)≤T_{z,max}. However, the boundaries T_{z;min} and T_{z;max} were rather arbitrarily set without sufficient consideration of occupants thermal comfort in previous studies. Occupants may have different thermal preferences depending on their physical constitutions. Some may feel cold at 23 degrees C. while others in the same thermal zone feel warm. The thermal preferences also can change according to short-term and long-term variations in diurnal and seasonal weather, respectively. The lack of attention to occupant thermal responses can cause occupants to complain and introduce human interruption to the optimal scheduling of HVAC units. In previous studies, controlling HVAC units for multiple-occupant spaces has relied on group-level representation of thermal comfort, mainly using predicted mean vote (PMV) models. PMV models have several drawbacks, including limitations in reflecting variation in behaviors (e.g., use of personalized fans) among individual occupants to adapt to thermal environments. Moreover, the optimal operation of HVAC units still needs to be achieved based on the acceptable range of the PMV index, similar to the maximum and minimum limits of zone-based temperatures.

### SUMMARY OF THE INVENTION

One exemplary object of the present disclosure is to provide a method for controlling power supply to a heating, ventilating, and air-conditioning (HVAC) system for a building based on a predetermined target temperature, by which a difference between the predetermined target temperature schedule and an actual temperature is minimized, wherein the predetermined target temperature may be determined by reflecting changes in time and space such that the building user may feel comfortable at the predetermined target temperature.

Another exemplary object of the present disclosure is to provide a device for controlling power supply to a heating, ventilating, and air-conditioning (HVAC) system for a building based on a predetermined target temperature, by which a difference between the predetermined target temperature schedule and an actual temperature is minimized, wherein the predetermined target temperature may be determined by reflecting changes in time and space such that the building user may feel comfortable at the predetermined target temperature.

However, the objects to be achieved by the present disclosure is not limited thereto, and various modifications may be made without departing from the spirit and scope of the present disclosure.

In a first aspect of the present disclosure, there is provided a method for controlling power supply to a heating, ventilating, and air-conditioning (HVAC) system for a building based on a target temperature, wherein the method comprises: generating a zone-based temperature prediction model by training an artificial neural network based on a plurality of first training data, wherein the zone-based temperature prediction model is configured to receive a building indoor temperature, a supplied power and building environment information at a plurality of time-points prior to a prediction timing and having a first time interval, and to predict a building indoor temperature at the prediction timing; and determining a sequence of optimal to-be-supplied powers at one or more time-points after a current time-point, wherein the sequence of optimal to-be-supplied powers allows minimizing a value of a loss function associated with a difference between a sequence of predetermined target temperatures and a sequence of predicted temperatures predicted based on the zone-based temperature prediction model, at said one or more time-points after the current time-point and having the first time interval.

In one embodiment, the building has a plurality of zones, wherein at least one of the indoor temperature, the building environment information, the target temperature and the predicted temperature is determined for each of the plurality of zones.

In one embodiment, each of the plurality of first training data comprises: a previous building indoor temperature, a previous supplied power and a previous building environment information, and a current building indoor temperature for each of the plurality of zones based on the previous building indoor temperature, and the previous supplied power and the previous building environment information.

In one embodiment, the building environment information comprises: at least one of an adjacent-zone temperature, an ambient temperature around the building, a cooling rate of the HVAC system, a thermal gain from a convective load in a zone, and a thermal gain from a radiative load in a zone.

In one embodiment, a value of the loss function is determined based on a sum of difference values between a sequence of predetermined target temperatures and a sequence of predicted temperatures predicted based on the zone-based temperature prediction model for each of the plurality of zones.

In one embodiment, the value of the loss function is computed by adding a weight to a difference between the target temperature and the predicted temperature in at least one zone of the plurality of zones, wherein the at least one zone accommodates therein an occupant with a high temperature sensitivity.

In one embodiment, the artificial neural network comprises a recurrent neural network (RNN).

In one embodiment, the artificial neural network comprises a Long Short Term Memory (LSTM).

In one embodiment, a value of the loss function is determined based on a sum of differences between target temperatures included in a sequence of the predetermined target temperatures and predicted temperatures at time-points corresponding to the target temperatures respectively.

In one embodiment, determining the sequence of optimal to-be-supplied powers comprises: initializing optimal to-be-supplied powers included in the sequence of the optimal to-be-supplied powers and at each of one or more time-points having the first time interval; determining a first optimal to-be-supplied power at a first time-point of said one or more time-points having the first time interval, wherein the first optimal to-be-supplied power allows minimizing a value of the loss function; and determining a second optimal to-be-supplied power at a second time-point after the first time-point, wherein the second optimal to-be-supplied power allows minimizing a value of the loss function computed when the optimal to-be-supplied power is updated to first optimal to-be-supplied power at the first time-point.

In one embodiment, initializing the optimal to-be-supplied powers comprises initializing the optimal to-be-supplied powers based on a K-Nearest Neighbor (KNN) scheme.

In one embodiment, initializing the optimal to-be-supplied powers comprises initializing the optimal to-be-supplied powers based on an average of K nearest input powers determined based on a Euclidean distance to the target temperature.

In one embodiment, determining the first optimal to-be-supplied power and determining the second optimal to-be-supplied power comprises, respectively, determining the first optimal to-be-supplied power and determining the second optimal to-be-supplied power based on a stochastic gradient descent (SGD) scheme performed over nᵢₜₑᵣ times iterations.

In one embodiment, in determining the first optimal to-be-supplied power and determining the second optimal to-be-supplied power, only variables for the supplied power in the zone-based temperature prediction model used to train the artificial neural network are variable while remaining variables are fixed.

In a second aspect of the present disclosure, there is provided a device for controlling power supply to a heating, ventilating, and air-conditioning (HVAC) system for a building based on a target temperature, wherein the device comprises a memory and a processor connected to the memory, wherein the processor is configured for: generating a zone-based temperature prediction model by training an artificial neural network based on a plurality of first training data, wherein the zone-based temperature prediction model is configured to receive a building indoor temperature, a supplied power and building environment information at a plurality of time-points prior to a prediction timing and having a first time interval, and to predict a building indoor temperature at the prediction timing; and determining a sequence of optimal to-be-supplied powers at one or more time-points after a current time-point, wherein the sequence of optimal to-be-supplied powers allows minimizing a value of a loss function associated with a difference between a sequence of predetermined target temperatures and a sequence of predicted temperatures predicted based on the zone-based temperature prediction model, at said one or more time-points after the current time-point and having the first time interval.

In one embodiment of the device, the building has a plurality of zones, wherein at least one of the indoor temperature, the building environment information, the target temperature and the predicted temperature is determined for each of the plurality of zones.

In one embodiment of the device, the processor configured for determining the sequence of optimal to-be-supplied powers is further configured for: initializing optimal to-be-supplied powers included in the sequence of the optimal to-be-supplied powers and at each of one or more time-points having the first time interval; determining a first optimal to-be-supplied power at a first time-point of said one or more time-points having the first time interval, wherein the first optimal to-be-supplied power allows minimizing a value of the loss function; and determining a second optimal to-be-supplied power at a second time-point after the first time-point, wherein the second optimal to-be-supplied power allows minimizing a value of the loss function computed when the optimal to-be-supplied power is updated to first optimal to-be-supplied power at the first time-point.

In a third aspect of the present disclosure, there is provided a computer readable storage medium having instructions, wherein when executed by a processor, the instructions allow the processor to control power supply to a heating, ventilating, and air-conditioning (HVAC) system for a building based on a target temperature, wherein when executed by the processor, the instructions allow the processor to: generate a zone-based temperature prediction model by training an artificial neural network based on a plurality of first training data, wherein the zone-based temperature prediction model is configured to receive a building indoor temperature, a supplied power and building environment information at a plurality of time-points prior to a prediction timing and having a first time interval, and to predict a building indoor temperature at the prediction timing; and determine a sequence of optimal to-be-supplied powers at one or more time-points after a current time-point, wherein the sequence of optimal to-be-supplied powers allows minimizing a value of a loss function associated with a difference between a sequence of predetermined target temperatures and a sequence of predicted temperatures predicted based on the zone-based temperature prediction model, at said one or more time-points after the current time-point and having the first time interval.

The disclosed technique may have following effects. It should be understood, however, that the scope of the present disclosure is not to be construed as limited thereto, as it is not meant that particular embodiments should include all of the following effects or only include the following effects.

In accordance with the method and device for controlling power supply to the heating, ventilating, and air-conditioning (HVAC) system for a building based on a predetermined target temperature, the difference between the predetermined target temperature schedule and an actual temperature may be minimized, wherein the predetermined target temperature may be determined by reflecting changes in time and space such that the building user may feel comfortable at the predetermined target temperature.

Thus, it is possible to reduce the inconveniences of the building user, and hence a risk of any interruption of a unit that automatically controls the HVAC system. Accordingly, it is possible to increase the likelihood that the actual energy consumption of the HVAC system matches the pre-scheduled consumption.

In addition, it is possible to adaptively control the HVAC system without requiring re-training of the artificial neural network, even when the user's thermal preference changes temporally or spatially after the initial training of the artificial neural network to predict the temperature inside the building.

### BRIEF DESCRIPTION OF THE DRAWINGS

FIG. 1 shows a building (specifically, multiple zones temperatures controlled by a HVAC system) to be tested according to one aspect of the present disclosure.

FIG. 2 shows a HVAC system as a system for controlling the multiple zone-based temperatures.

FIGS. 3A and 3B illustrate an architecture of a model for optimizing control of an HVAC system based on an LSTM network.

FIG. 4 shows a flow chart of an algorithm for scheduling an input power to the HVAC according to one embodiment of the present disclosure.

FIG. 5 shows a power scheduling algorithm according to one embodiment of the present disclosure.

FIG. 6 is a flow chart of a method for controlling power supply to the heating, ventilating, and air-conditioning (HVAC) system for a building based on a target temperature, according to one embodiment of the present disclosure.

FIG. 7 is a detailed flow chart of an operation to determine t a sequence of optimal to-be-supplied powers in FIG. 6.

FIG. 8 is a block diagram of a configuration of a device for controlling power supply to the heating, ventilating, and air-conditioning (HVAC) system for building based on a target temperature according to one embodiment of the present disclosure.

### DETAILED DESCRIPTION OF THE INVENTION

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

A few studies have been presented attempting to achieve the optimal control of the zone-based temperatures and consequently occupants thermal comfort by using deep learning (DL) and reinforcement learning (RL) algorithms; however, it was accomplished still for the acceptable range of the zone-based temperatures, which was arbitrarily and uniformly set for all thermal zones within the test buildings. The temporal and spatial variations in occupants thermal preferences were not taken into account in the studies. The artificial neural networks presented the prior study consequently need to be retrained to determine the optimal power inputs of the HVAC system for the desirable variations in multi-zone-based temperatures, leading to significant increases in required computational time and building data. This will limit the applicability of the control methods in the prior studies to large-scale multi-zone buildings in practice where the number, types, and activity schedules of occupants continuously change.

A control scheme in accordance with one embodiment of the present disclosure enables building information modeling systems (BIMSs) to operate HVAC systems to minimize the difference between the scheduled zone-based temperatures (hereinafter, “target temperatures) and actual zone-based temperatures, rather than to focus merely on the operating cost of HVAC systems. Occupants thermal comforts are related directly to their productivity outcomes, which are valued at up to 13 times greater than energy costs. In addition, the control scheme in accordance with one embodiment of the present disclosure is expected to mitigate the risk of occupant complaints and human interruption, which consequently increases the possibility that the actual energy consumption of the HVAC units is consistent with the scheduled consumption. This implies that the control strategy is more cost-effective and occupant-friendly in practical application than previous ones, where only the zonal temperatures are uniformly controlled without consideration of the thermal preferences of individual occupants.

With the developments of communication, sensing, and computing technologies, BIMSs can be interfaced with a cloud or on-premise data server storing a huge amount of data on indoor and outdoor environments (e.g., zone-based temperature, ambient temperature, ground temperature, solar insulation, and convex and latent heat gains) and HVAC system operations (e.g., input power, cooling rates, compressor rotational speed, and fan speed). Using the data, optimal power inputs of HVAC units can be determined to maintain the zone-based temperatures at a corresponding set-point (hereinafter, “target temperature”). However, in the prior studies, the temporal and spatial variations in occupants thermal preferences were not taken into account. The artificial neural networks presented in the prior studies consequently need to be retrained to determine the optimal power inputs of the HVAC system for the desirable variations in multi-zone-based temperatures, leading to significant increases in required computational time and building data. This will limit the applicability of the control methods in the prior studies to large-scale multi-zone buildings in practice where the number, types, and activity schedules of occupants continuously change.

Based on these observations, in accordance with one aspect of the present disclosure, there is provided a novel method to determine the optimal power inputs (or controllable inputs) of HVAC systems, given that the target temperatures of the zone-based temperatures have to change due to various building internal and external conditions such as occupants activities, weather forecasts, and building energy policies. The optimal power inputs will be estimated without the retraining of the trained ANNs; therefore, the control method in accordance with one aspect of the present disclosure is effective in determining the daily operating schedules of the HVAC system under the condition that the data on the occupants and building environment is not significantly accumulated.

In accordance with one aspect of the present disclosure, the control method is summarized as follows. First of all, the deep neural network model is trained which uses environment and control variable as input, and the indoor temperature as output. In this connection, the RNN is implemented, trained and utilized, given the practical limitations on the RL algorithms. In other words, training the artificial neural network based on the first series of training data may allow a zone-based temperature prediction model to be generated that may predict the indoor temperature of the building. The zone-based temperature prediction model may receive a building indoor temperature, a supplied power, and building environment information corresponding to each of a plurality of time-points having a first time interval, prior to a timing at which the indoor temperature is to be predicted and then may be trained to output an indoor temperature at the prediction timing at which the indoor temperature is to be predicted.

Next, an optimal power supply schedule may be determined that also allows the user to achieve thermal comfort. The optimal to-be-supplied power may be determined such that the difference between each preset target temperature and the predicted temperature predicted based on the zone-based temperature prediction model at one or more time-points having the first time interval after the current time-point is minimized. Specifically, a loss function (determined, for example, based on the difference between the target and predicted temperatures) is formulated with the appropriate indoor temperature as received in real time, Control variables (e.g., optimal to-be-supplied powers) that optimize the loss function may be computed in real time. To obtain the control variables, a gradient descent (GD) algorithm may be used which modifies the learning parameters and distinguishes between the control variables.

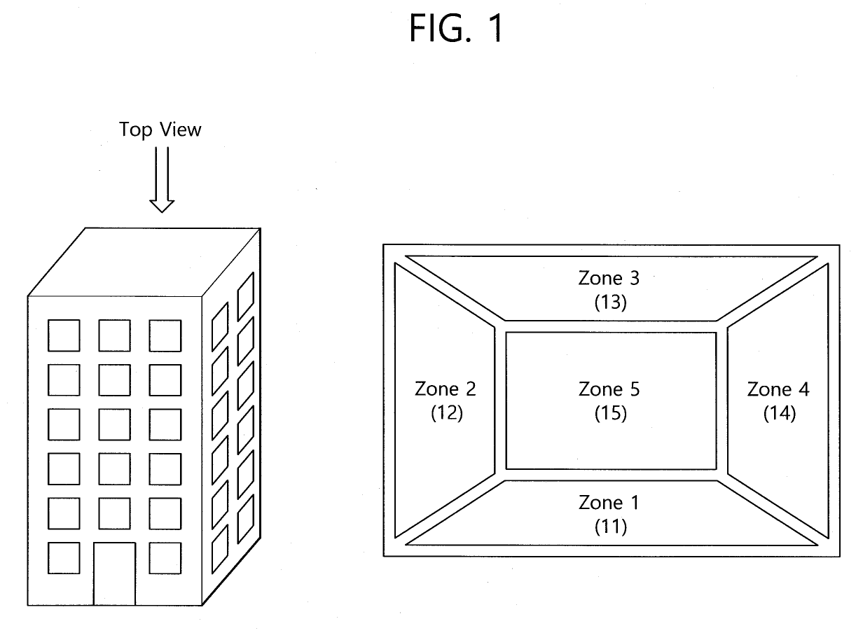

FIG. 1 shows the building (with multiple zone-based temperatures controlled by the HVAC system) to be tested according to one aspect of the present disclosure. A building model according to one aspect of the present disclosure may be a multiple zone building 10 having five zones 11, 12, 13, 14, and 15 in the same layer as shown in FIG. 1. The test building may have asymmetric thermal loading, as thermal zones have different profiles for internal and external heat gains during the day.

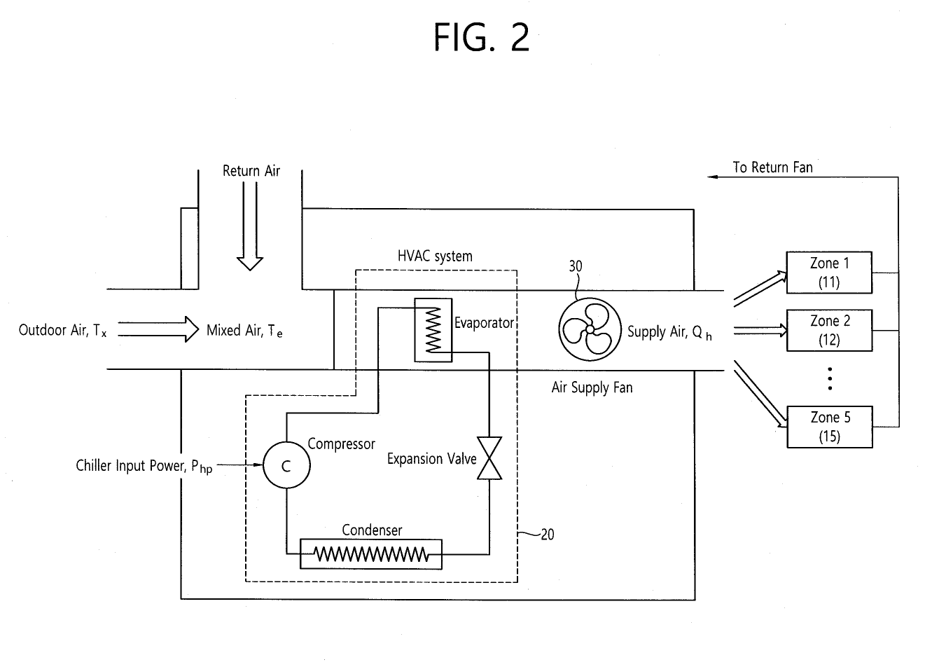

FIG. 2 shows the HVAC system, which is the control system for multiple zone-based temperatures. As shown in FIG. 2, the HVAC system operates with the air supply fan 30 and VAV boxes 20 to divide supplied air Q^{t}ₕ into Q^{t}_{hz} (where, z=1; 2; . . . ; N_{z}) in proportion to the heat gains in each zone 11, 12, . . . , 15. Therefore, it is not possible to make every zone maintains temperature in the same time duration. Therefore, different weights may be added to zone-based temperature differences. To solve this constrained optimization problem, the applicant takes the iterative gradient descent steps on the input power on HVAC unit as stated above. The approach does not need analysis on complex interactions within conduction, convection or radiation processes. It is expected to be applied to large buildings. For simplicity, only the chiller is considered as the controllable resource in this study, given the assumption that the air supply fan operates at the rated power and speed. The coordination of the chiller with the air supply fan can be effective in reducing energy consumption, which is not further discussed herein.

The existing studies established the algorithm to schedule minimum heat pump input for the efficient operating of the HVAC system. Beyond the efficiency, the main contributions of the present disclosure are as follows:

In accordance with one embodiment of the present disclosure, there is provided a model which can select each proper temperature for each zone and schedule the HVAC input power to minimize the thermal discomfort of occupants.

In accordance with one embodiment of the present disclosure, the applicant may put the zonal priorities with the weighted coefficients and time-varying, or seasonal, proper temperatures to the model.

In accordance with one embodiment of the present disclosure, the above contributions may be applied to the building operating on occupancy. If there are people who is sensitive to temperature difference, building manager can place those people to the specific zone where the weighted coefficient is large, or the priority is high. On the contrary, coefficients of the zones with the sensitive people could be weighted more than the others to minimize the thermal discomfort more. It means that buildings can operate focusing on the occupants productivity which could be more valuable in the future.

Hereinafter, the building environment model which the applicant simulates and data characteristics in building model are explained. It is explained the algorithm how to train the data and optimal operation of the HVAC system. Finally, the algorithm is validated.

Building Thermal Response to HVAC System Operation

In accordance with one embodiment of the present disclosure, the thermal response of a multi-zone building was modeled based on the DOE commercial reference building for small offices as shown in FIG. 1. It may be assumed that the test room includes several heat sources such as lights and humans and it may be simulated as the heat gain. This thermal response model may be implemented using an inverse transfer function as shown in a mathematical expression to reflect the linear dependencies on external and internal environmental parameters during past and current time periods:

$${T}_{z} ( t ) = {\sum }_{k = t - 3}^{t - 1} {a}_{k} {T}_{z} ( k ) + {\sum }_{k = t - 3}^{t} ( {b}_{k} {T}_{adj} ( k ) + {c}_{k} {T}_{amb} ( k ) + {d}_{k} {Q}_{cool} ( k ) + {e}_{k} {Q}_{hgc} ( t ) + {f}_{k} {Q}_{hgr} ( k ) ) , ∀ t \qquad [ Mathematical expression 1 ]$$

where T_{z} is the indoor temperature controlled by the HVAC system. The temperature may influence on the thermal discomfort. Thus, the applicant wants to make the temperature to be equal to the set temperature (or target temperature). T_{adj} refers to the adjacent room temperature and T_{amb} refers to the ambient temperature nearby the building. Q_{cool} refers to the cooling rate from the HVAC unit and Q_{hgc} and Q_{hgr} respectively refer to the heat gains from internal convective and radiative loads. The coefficients aₜ to fₜ rely on the building structure and orientation. The adjacent and ambient temperatures, and the internal heat gains may be calculated using building operation history data. Using gₜ, representing the building-wide environmental parameter, the math expression (1) may be simplified into a following math expression (2):

$${T}_{z} ( t ) = {\sum }_{k = t - 3}^{t - 1} {a}_{k} {T}_{z} ( k ) + {\sum }_{k = t - 3}^{t} ( {d}_{k} {Q}_{cool} ( k ) + {g}_{k} ) , ∀ t \qquad [ Mathematical expression 2 ]$$

This thermal response model is available for application to large-scale and multi-zone and single zone building both, so long as the different coefficient in the expression (1) is selected appropriately. Up to this, the thermal response model has been developed to simulate the input power scheduling algorithm. The simulation algorithm and results will be discussed below.

Deep Neural Network for Building Thermal Dynamics

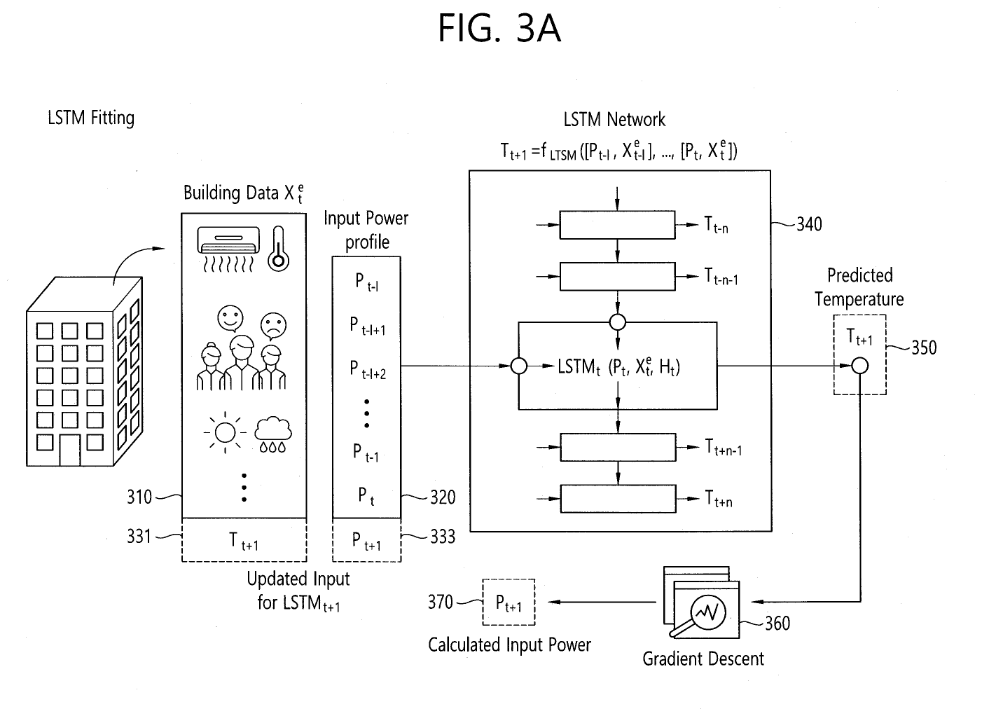

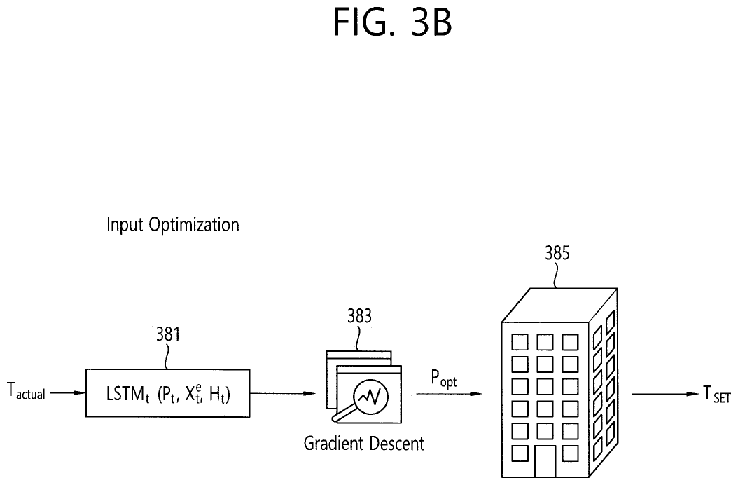

In accordance with one embodiment of the present disclosure, the applicant proposes a two-phase method to model and optimize building HVAC system. FIG. 3 illustrates the overall process of the method. Specifically, FIGS. 3a and 3b show the architecture of the model for optimizing the control of the HVAC system based on the LSTM network.

A data-driven deep learning approach enables a building model to represent the thermal dynamics of the building without any physical assumption. Given building operation history data, the applicant solves a regression problem that aims to generate proper outputs with specific inputs, the applicant train a deep neural network to predict the building zone-based temperatures T_{z} (z=1, . . . , 5) at a given time t, so that the present deep neural network successfully represent the thermal dynamics of the building. Since the zone-based temperatures are affected by the amount of power supplied to HVAC system and building environment measurements of past timesteps, Long Short-Term Memory (LSTM) is appropriate to capture the relationship between sequential inputs and outputs.

LSTM is a kind of Recurrent Neural Network (RNN) which is designed to handle long-term dependencies. A standard RNN cannot learn long-term dependencies due to the vanishing gradient problem. As an error backprogates through layers, it becomes too small to recover the output in forward propagation. Given input sequences x₀, . . . , x₁, the network outputs corresponding hidden states and outputs. At each time step t, a hidden state hₜ is determined by the previous state hₜ₋₁ and the current input xₜ. An output yₜ is determined by hₜ. In one example of the present disclosure, the input is a sequence of powers to be supplied to the HVAC system and building environment measurements such as heat gain, ambient temperature, and solar energy of each zone of the building over time. Output is zone-based temperatures.

The loss function L_{LSTM} for training is the sum of squared errors as shown in a following math expression 3:

$${L}_{LSTM} = {\sum }_{t} {( {\hat{y}}_{t} - {y}_{t} )}^{2} \qquad [ Mathematical expression 3 ]$$

where [symbol] ₜ denotes prediction made by the deep neural network and [symbol] ₜ denotes target.

In one embodiment of the present disclosure, the applicant takes stochastic gradient descent (SGD) method to find the optimal network parameter θ* that minimizes the loss as follows:

$${θ}^{*} = arg {min}_{θ} {L}_{LSTM} \qquad [ Mathematical expression 4 ]$$

The SGD is a variant of Gradient Descent (GD) algorithm. In gradient computing steps, SGD computes gradients of a part of the whole data points called mini-batch while GD applies gradients to all data points. It is known that the result of SGD converges to the similar point where GD does. It may even get out of local optima and converge to a better optimal point.

Once the training is done, the LSTM network in accordance with the present disclosure represents the thermal dynamics of the building successfully.

As shown in FIG. 3A, a zone-based temperature prediction model according to one embodiment of the present disclosure may be generated by training and fitting an artificial neural network (e.g., LSTM). That is, the zone-based temperature prediction model may be generated by training an artificial neural network 340 based on a plurality of first training data. The zone-based temperature prediction model may be configured to receive environment variables 310 (e.g., building data including building indoor temperature and building environment information) and control variables (e.g., input power profiles at previous timings) 320, at a plurality of time-points (t−1 to t) having a first time interval (which may be represented +1 in FIG. 3) and prior to the prediction timing, and may be configured to predict the indoor temperature at the prediction timing (t+1). The optimal calculated to-be-supplied power 370, which may minimize the difference between the temperature at the prediction timing (t+1) and the preset target temperature, may be calculated by the gradient descent 360 technique. The predicted temperature 350 and the calculated to-be-supplied power 370 may be used as the inputs of the temperature 331 and supplied power 333 at the t+1 time-point in the LSTM network 340 to determine the predicted temperature at the time-point t+2 after the first time interval elapses from the time-point t+1.

In order to optimize the power supply according to one aspect of the present disclosure, as shown in FIG. 3B, the actual temperature T_{actual} is input to the zone-based temperature prediction model 381. In this response, the optimal to-be-supplied power may be determined using the gradient descent 385 technique based on the predicted temperature. Thus, the indoor temperature of the building 385 may be set to a predetermined target temperature T_{SET}.

Optimal Power Scheduling of HVAC System

With the present building model (zone-based temperature prediction model) as obtained, the optimal power schedule over time interval 1 may be determined that makes the zone-based temperature be the pre-set temperature set point (or target temperature). This preset target temperature may be a user parameter that the HVAC system operator provides. As the target temperature may vary with different zones in the building and time, the applicant adopts a matrix Tₛₑₜ=[\tilde{T}ₜ^{z}] to denote the pre-set temperatures over the scheduling time interval 1, where \tilde{T}ₜ^{z} may be the pre-set target temperature of the z-th zone at a time t.

To find the optimal to-be-supplied power, the loss function to be minimized may be to be defined first. The loss function may have the form of squared error with respect to the predicted zone-based temperatures and the pre-set zone-based temperatures. The applicant may take advantage of the present pre-trained LSTM network to predict the zone-based temperatures. Thus, the loss function Lₚ may be defined as follows:

$${L}_{p} = {\sum }_{j = 0}^{l} {\sum }_{z = 1}^{5} {( {f}_{LSTM , z} ( {X}_{t - l + j}^{z} , … , {X}_{t + j}^{z} ) - {\tilde{T}}_{t + 1 + j}^{z} )}^{2} \qquad [ Mathematical expression 5 ]$$

where f_{LSTM,z}(⋅) denotes the z-th zone temperature generated by the pre-trained LSTM, \tilde{T}ₜ^{z} denotes the pre-set temperature set point of the z-th zone at a time t, and X_{z}^{t}=[Pₜ, Xₜ^{e}, Tₜ^{z}]. That is, the input of the LSTM model may be the supplied power, the building environment information, and the zone temperature at the previous time intervals.

The optimal to-be-supplied power schedule for the HVAC system to minimize the loss Lₚ may be expressed as [P_{t+T}*] in a following math expression 6:

$${P}_{t + τ}^{*} = arg {min}_{{P}_{t + τ}} {L}_{p} \qquad [ Mathematical expression 6 ]$$

In this connection, τ=0, . . . , l−1.

To obtain the optimal power schedule, the applicant may apply the stochastic gradient descent (SGD) algorithm with respect to Pₜ, . . . , Pₜ₊ₗ₋₁. Since SGD is an iterative method, the applicant may first initialize the input power Pₜ, . . . , Pₜ₊ₗ₋₁. Xavier initialization may be a widely-used method for initializing the neural network weights. The present disclosure may not be limited thereto. In one embodiment, the applicant may propose a new initialization method for the input power. Hereinafter, the initialization method and then an update rule for the SGD will be described.

K-Nearest Neighbor-Based Initialization Using k-d Tree Structure

Applying the SGD to the input power P_{t+τ} may lead to different local optima depending on initial values. In other words, good initialization allows P_{t+τ} to converge to a better optimum. In one embodiment, the applicant proposes a K-Nearest Neighbor (KNN)-based method for initializing P_{t+T}.

Given pre-set temperatures (\tilde{T}ₜ₊ₗ¹, . . . , \tilde{T}ₜ₊ₗⁿ) of the n zones in the building, the present disclosure is to initialize Pₜ, . . . , Pₜ₊ₗ₋₁. To find KNN in an n-dimensional space, k-d tree is used to reduce computational cost for sufficiently small n, i.e. n<20. As the present disclosure uses pre-set zone temperatures for KNN search, n remains small (i.e. n=5 in one example) to take advantage of the k-d tree. The present disclosure first constructs a k-d tree with (Tᵢ¹, . . . , Tᵢⁿ). Note that i=1, . . . , N where N is the total number of data points in the dataset. Once the tree is constructed, distances between query and data points are computed for average O (log N) times. Distance measure used to determine K nearest neighbors is Euclidean distance defined as dᵢ=Σ_{z=1}ⁿ\sqrt{(\tilde{T}ₜ₊ₗ^{z}, . . . , \tilde{T}ᵢ^{z})²}. As the dataset itself is a reference table, it is straightforward to identify their corresponding input powers in the same entry using the K nearest neighbors of (\tilde{T}ₜ₊ₗ¹, . . . , \tilde{T}ₜ₊ₗⁿ) as obtained. These K input powers functions as K nearest neighbors of P_{t+τ} to be initialized. In one embodiment of the present disclosure, the initial power may be set as the average of K nearest input powers.

The KNN-based initialization method in accordance with the present disclosure may be regarded as data-driven pre-training of input powers since the original dataset is referred to for reflecting the characteristic of given data.

Update Rule for SGD

In one embodiment of the present disclosure, the weight parameters of the pre-trained LSTM may be fixed so that only input power variables remain changeable during step-wise descents. P_{t+τ} may be updated step by step by a update rule based on a following math expression 7:

P_{t+τ}←P_{t+τ}−η∇_{P}_{_{t+τ}}Lₚ [Mathematical expression 7]

where, η refers to a learning rate. This step is repeated for nᵢₜₑᵣ iterations so that P_{t+τ}, converges to an optimum.

In one embodiment, the loss function Lₚ must be recomputed after nᵢₜₑᵣ-step updates of P_{t+τ} to reflect the effect of P_{t+τ} on the next timestep zone temperature T_{t+1+τ}^{z}. As the input variable Xₜ^{z} of f_{LSTM,z} contains Pₜ in itself, the predicted temperature consistently changes after Pₜ becomes an optimum Pₜ* as calculated by the SGD.

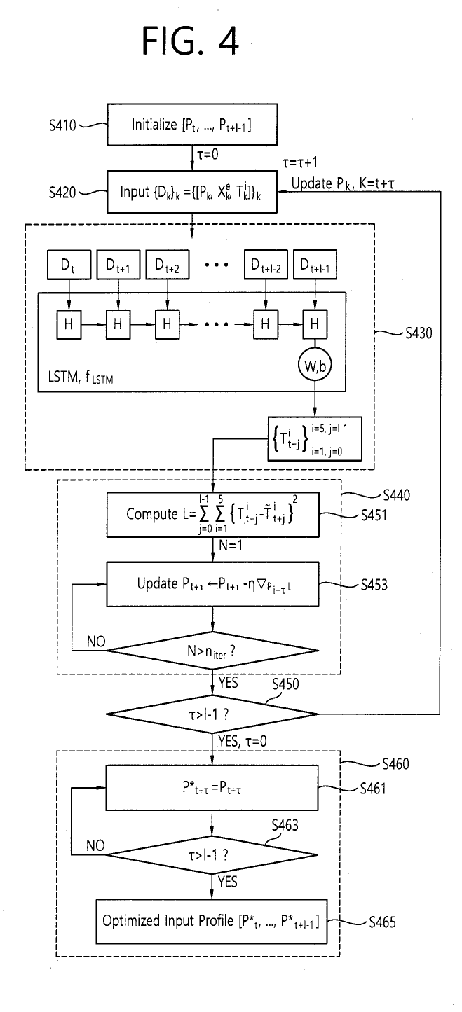

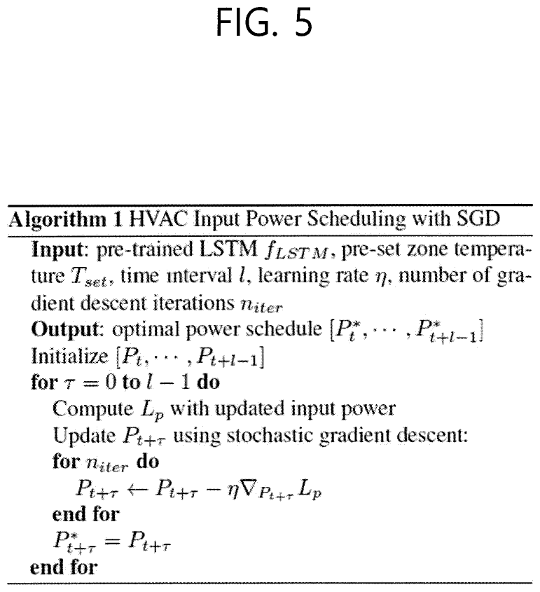

FIG. 4 shows a flow chart of an algorithm for scheduling an input power to the HVAC according to one embodiment of the present disclosure. FIG. 5 shows a power scheduling algorithm according to one embodiment of the present disclosure. The algorithm 1 describes the overall optimization scheme for building HVAC system control in accordance with one embodiment. The flow chart of the algorithm is detailed with reference to FIG. 4.

As shown in FIG. 4, in the initialization step S410, first, the input powers may be initialized to appropriate values. Thereafter, the initialized values may be input to the input data D. According to one aspect, the above-described KNN technique may be used to initialize a sequence of optimal to-be-supplied powers.

In the subsequent input (update) step S420, the input data D to be input to the learned model may be determined. In FIG. 4, illustratively, D={D0, D1, . . . , D23} may be entered for 24 hours of the day. In other words, the time interval 1 in FIG. 4 may have a value of 24.

$$D = {\{ {D}_{k} \}}_{k = 0}^{k = 23} = {\{ {P}_{k} , {X}_{k}^{e} , {T}_{k}^{1} , … , {T}_{k}^{5} \}}_{k = 0}^{k = 23}$$

where Pₖ may represent the input power at time k, X^{e}ₖ may represent the environmental variable at time k (e.g., cooling rate, thermal gain, adjacent zone temperature, etc.), Tⁱₖ may represent temperature in a zone i (i=1, . . . , 5) at a time k.

Thereafter, in the temperature prediction step S430 using the zone temperature determination model, the predicted temperature in each zone may be calculated using the learned zone temperature model.

$$( LSTM output ) = {\{ {T}_{j}^{i} \}}_{i = 1 , j = 0}^{i = 5 , j = 23} = \{ {T}_{0}^{1} , … , {T}_{23}^{1} , {T}_{0}^{2} , … , {T}_{23}^{2} , … , {T}_{0}^{5} , … , {T}_{23}^{5} \}$$

In one example, the temperature in each of zone 1 through zone 5 from 0 to 23 hours may be predicted.

In the optimization phase S440, the input power Pτ, which may minimize the difference between the expected temperature and the zone-based target temperature, may be computed using the gradient descent algorithm. In this regard, τ+1 may represent the number of iterations. For example, in the first iteration, P₀ may be computed. In the fifth iteration, P₄ may be computed. The optimizing step comprises computing a difference L between the expected or predicted temperature and the zone-based target temperature S451 and updating the optimal power using the gradient descent algorithm via nᵢₜₑᵣ iterations S453.

In the repeating step S450, in order to obtain a sequence of optimal to-be-supplied powers for a preset time interval 1, operations 420 to 440 may be repeated until τ becomes l−1. That is, Pτ computed at the operation 440 may be updated into the input power corresponding to the input data D at the operation 420 in the next iteration. The operations 420 to 440 are repeated 1 time (e.g., 24 times). Thus, new P₀, . . . , P₂₃ may be computed to determine the sequence of optimal to-be-supplied powers.

In output step S460, for the final output from the algorithm, the sequences of optimal to-be-supplied powers may be outputted as an optimized input profile. Setting the computed power input to the optimal to-be-supplied power S461 may be repeated from the time point t to the time point t+l−1 S463. Finally, the optimized input profile may be output S465.

Algorithm Validation

The algorithm in accordance with one embodiment of the present disclosure may be validated in following two schemes.

In a first scheme, the regression results of the temperature prediction model according to one embodiment of the present disclosure and according to the conventional method and are compared with each other.

In a second scheme, the optimal power schedules as generated by the conventional method and the model according to the present disclosure are compared with each other.

The present disclosure may implement LSTM network using PyTorch, an opensource framework for deep learning. The network may be composed of a 1 layer in LSTM followed by a 1 fully connected (FC) layer. Each FC layer has 100 neurons. The activation function for FC layers is Rectified Linear Unit (ReLU). The whole dataset extracted from the simulator consists of 51,240 entries having time interval of 1 hour. One example of the present disclosure may use 80% of the whole data as a training set, the rest 10% as a test set and the rest 10% as a validation set.

In accordance with one aspect of the present disclosure, there is provided an optimal HVAC control algorithm to minimize thermal discomfort and electricity cost using RNN algorithm by learning from existing data and predicting how much the input power is applied in the next day. With this approach, it may be more efficient to control the HVAC system of each building when the building HVAC unit has sufficient data set. Simulation results show that the present algorithm performs well in respect of thermal dynamics and economics.

Method for Controlling Power Supply to HVAC System

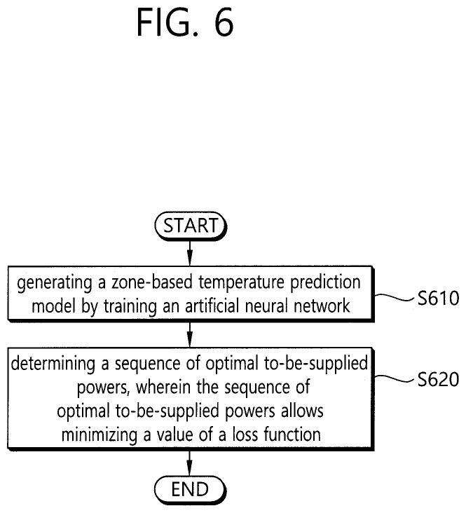

FIG. 6 is a flow chart of the method for controlling the power supply to the building's heating, ventilating, and air-conditioning (HVAC) system based on a target temperature according to one embodiment of the present disclosure. Referring to FIG. 6, the applicant will explain how to control the power supply to the HVAC system according to one embodiment of the present disclosure.

As shown in FIG. 6, in a control method according to one embodiment of the present disclosure, a zone-based temperature prediction model may first be generated (S610). Specifically, the method may include generating a zone-based temperature prediction model by training an artificial neural network based on a plurality of first training data, wherein the zone-based temperature prediction model is configured to receive a building indoor temperature, a supplied power and building environment information at a plurality of time-points prior to a prediction timing and having a first time interval, and to predict a building indoor temperature at the prediction timing. In one example, the training of the zone-based temperature prediction model has been described in “Deep Neural Network for Building Thermal Dynamics” section.

For example, as shown in FIG. 3, the zone-based temperature prediction model may be configured to receive environment variables, for example, building data including building indoor temperature and building environment information, and control variables for example, supplied power profiles, at a plurality of time-points from a previous timing t−1 to a current timing t having a first time interval and prior to the prediction timing t+1 at which the temperature is to be predicted, and may be configured to predict and output the indoor temperature Tₜ₊₁ at the prediction timing t+1. In one embodiment, the building has a plurality of zones, wherein at least one of the indoor temperature, the building environment information, the target temperature and the predicted temperature is determined for each of the plurality of zones. The indoor temperature at the previous time points may be acquired and input for each zone. The building environment information may also be obtained for each zone. Therefore, the predicted temperature, which is the output of the zone-based temperature prediction model, may also be predicted for each zone.

In one embodiment, each of the plurality of first training data comprises: a previous building indoor temperature, a previous supplied power and a previous building environment information, and a current building indoor temperature for each of the plurality of zones based on the previous building indoor temperature, and the previous supplied power and the previous building environment information.

Since the previous temperature and environment variables, and the supplied powers affect the temperature at the prediction time point in the artificial neural network for training the zone-based temperature prediction model, the model may advantageously employ a recurrent neural network (RNN), especially LSTM as previously discussed.

Referring back to FIG. 6, an optimal power supply schedule may be determined that also allows the user to achieve thermal comfort. That is, the optimal to-be-supplied power may be determined S620 such that the difference between each preset target temperature and the predicted temperature predicted based on the zone-based temperature prediction model is minimized, wherein the predetermined or preset target temperature may be determined by reflecting changes in time and space such that the building user may feel comfortable at the predetermined target temperature. Thus, the method may include determining a sequence of optimal to-be-supplied powers at one or more time-points after a current time-point, wherein the sequence of optimal to-be-supplied powers allows minimizing a value of a loss function associated with a difference between a sequence of predetermined target temperatures and a sequence of predicted temperatures predicted based on the zone-based temperature prediction model, at said one or more time-points after the current time-point. Said one or more time-points may have the first time interval. According to one aspect, the determination of the optimal power supply schedule may be as described earlier in the “Optimum Power Scheduling for HVAC System” section.

For example, as described with reference to FIG. 4, the sequence of the optimal to-be-supplied powers [P_{t+τ}*] may be determined such that that the value of the loss function L representing the difference between the predetermined target temperature and the temperature predicted by the above-described zone-based temperature prediction model at each time point and in each zone, for a plurality of time points from the current timing t to a timing t+l−1 having the first time interval is minimized. In this connection, T=0, . . . , l−1.

In one embodiment, a value of the loss function is determined based on a sum of differences between target temperatures included in a sequence of the predetermined target temperatures and predicted temperatures at time-points corresponding to the target temperatures respectively. In one example, a value of the loss function is determined based on a sum of squared differences between target temperatures included in a sequence of the predetermined target temperatures and predicted temperatures at time-points corresponding to the target temperatures respectively.

In one embodiment, when the building has the plurality of zones, a value of the loss function is determined based on a sum of difference values between a sequence of predetermined target temperatures and a sequence of predicted temperatures predicted based on the zone-based temperature prediction model for each of the plurality of zones. In one embodiment, the value of the loss function is computed by adding a weight to a difference between the target temperature and the predicted temperature in at least one zone of the plurality of zones, wherein the at least one zone accommodates therein an occupant with a high temperature sensitivity. Thus, for a first zone where the occupant with a high thermal sensitivity is located, the difference between the target temperature and the predicted temperature further increases the value of the loss function. Thus, the determination of the optimal to-be-supplied power may be performed to further lower the temperature difference for the first zone.

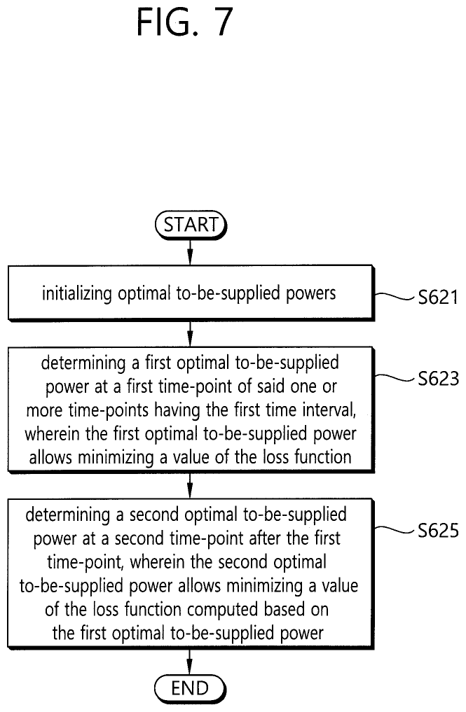

FIG. 7 is a detailed flow chart of an operation to determine t a sequence of optimal to-be-supplied powers in FIG. 6. As shown in FIG. 7, determining the sequence of optimal to-be-supplied powers S620 comprises: initializing optimal to-be-supplied powers (Pₜ, . . . , Pₜ₊ₗ₋₁) included in the sequence of the optimal to-be-supplied powers and at each of one or more time-points having the first time interval S621. In one embodiment, initializing the optimal to-be-supplied powers S621 comprises initializing the optimal to-be-supplied powers based on a K-Nearest Neighbor (KNN) scheme. To be specific, initializing the optimal to-be-supplied powers S621 comprises initializing the optimal to-be-supplied powers based on an average of K nearest input powers determined based on a Euclidean distance to the target temperature. According to one embodiment, the initialization S621 may be executed as described with reference to the operation 410 of FIG. 4 or to a “K-Nearest Neighbor-based Initialization using k-d tree structure” section.

Referring aging to FIG. 7, determining the sequence of optimal to-be-supplied powers S620 comprises: determining a first optimal to-be-supplied power Pₜ* at a first time-point (for example, a t timing) of said one or more time-points having the first time interval S623, wherein the first optimal to-be-supplied power allows minimizing a value of the loss function. Then, determining the sequence of optimal to-be-supplied powers S620 comprises: determining a second optimal to-be-supplied power at a second time-point (for example, a timing t+1) after the first time-point S625, wherein the second optimal to-be-supplied power allows minimizing a value of the loss function computed when the optimal to-be-supplied power is updated to first optimal to-be-supplied power at the first time-point. That is, the optimal to-be-supplied power as determined at the first time, which is the previous time, affects the zone temperature at the second time, which is the next time. Thus, the optimal to-be-supplied power as determined at the first time, which is the previous time is updated to an input power at the first time. With the update, the loss function at the second time point is calculated again. In this connection, the to-be-supplied power at the second time point allowing minimizing the value of the re-calculated loss function may be determined as the optimal to-be-supplied power at the second time point.

In one embodiment, in determining the first optimal to-be-supplied power S623 and determining the second optimal to-be-supplied power S625, a stochastic gradient descent (SGD) scheme may be employed. That is, determining the first optimal to-be-supplied power S623 and determining the second optimal to-be-supplied power S625 comprises, respectively, determining the first optimal to-be-supplied power and determining the second optimal to-be-supplied power based on a stochastic gradient descent (SGD) scheme performed over nᵢₜₑᵣ times iterations.

In one embodiment, in determining the first optimal to-be-supplied power S623 and determining the second optimal to-be-supplied power S625, only variables for the supplied power in the zone-based temperature prediction model used to train the artificial neural network are variable while remaining variables are fixed. That is, the zone-based temperature prediction model is trained once. Then, the power to be supplied to the HVAC system may be adaptively controlled with respect to the target temperature as determined in consideration of the thermal preference of the user, which may change temporally and spatially.

A Device for Controlling Power Supply to a Heating, Ventilating, and Air-Conditioning (HVAC) System

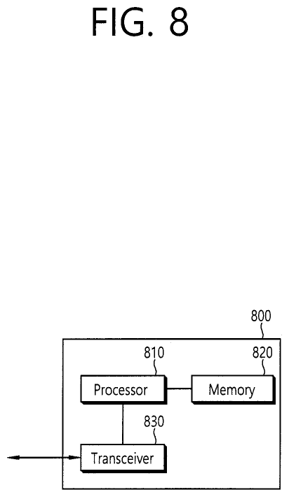

FIG. 8 is a block diagram of a configuration of a device for controlling power supply to the heating, ventilating, and air-conditioning (HVAC) system for building based on a target temperature according to one embodiment of the present disclosure. As shown in FIG. 8, a device 800 for controlling the power to be supplied to the HVAC system may include a processor 810, a memory 820, and a transceiver 830.

In one embodiment, the processor 810 may be configured for: generating a zone-based temperature prediction model by training an artificial neural network based on a plurality of first training data, wherein the zone-based temperature prediction model is configured to receive a building indoor temperature, a supplied power and building environment information at a plurality of time-points prior to a prediction timing and having a first time interval, and to predict a building indoor temperature at the prediction timing; and determining a sequence of optimal to-be-supplied powers at one or more time-points after a current time-point, wherein the sequence of optimal to-be-supplied powers allows minimizing a value of a loss function associated with a difference between a sequence of predetermined target temperatures and a sequence of predicted temperatures predicted based on the zone-based temperature prediction model, at said one or more time-points after the current time-point and having the first time interval. The specific operation of the processor 810 may be in accordance with the method for controlling the power supply to the HVAC according to the embodiment of the present invention as described above.

According to one embodiment, the memory 820 may store instructions for operations of the processor. In addition, the generated zone-based temperature prediction model may be stored in the memory 820 or may be configured to be stored and operated in a separate remote or near-site server via transmitting and receiving information through the transceiver 830.

A device 800 according to an embodiment of the present invention may be formed integrally with a building information modeling system (BIMS), or may be provided as a separate device. When the device 800 is provided as a separate device, the device 800 may be configured to transmit and receive information to and from the BIMS via the transceiver 830.

The method according to an embodiment of the present invention can be implemented as computer-readable instructions on a computer-readable recording medium. The computer-readable recording medium comprises all kinds of recording media storing data which can be interpreted by a computer system. For example, the computer-readable recording medium may include a Read Only Memory (ROM), a Random Access Memory (RAM), a magnetic tape, a magnetic disk, a flash memory, an optical data storage device, and the like. In addition, the computer-readable recording medium may be distributed in computer systems connected to a computer network, and may be stored and executed as a code readable in a distribution manner.

While the present invention has been described with reference to the accompanying drawings and exemplary embodiments, it is to be understood that the invention is not limited by the accompanying drawings and embodiments. It will be understood by those skilled in the art that various changes in form and details may be made therein without departing from the spirit and scope of the invention as defined by the appended claims.

In particular, the described features may be implemented within digital electronic circuitry, or computer hardware, firmware, or combinations thereof. The features may be implemented in a computer program product embodied in a storage device in a machine-readable storage device, for example, for execution by a programmable processor. Also, the features may be performed by a programmable processor executing a program of instructions for performing functions of the described embodiments, by operating on input data and generating an output. The described features may be implemented in at least one computer programs that can be executed on a programmable system including at least one programmable processor, at least one input device, and at least one output device which are combined to receive data and directives from a data storage system and to transmit data and directives to the data storage system. A computer program includes a set of directives that can be used directly or indirectly within a computer to perform a particular operation on a certain result. A computer program may be written in any form of programming language including compiled or interpreted languages, and may be used in any form included as modules, elements, subroutines, or other units suitable for use in other computer environments or independently operable programs.

Suitable processors for execution of the program of directives include, for example, both general-purpose and special-purpose microprocessors, and a single processor or one of multiple processors of other type of computer. In addition, storage devices suitable for implementing the computer program directives and data implementing the described features include, for example, semiconductor memory devices such as EPROM, EEPROM, and flash memory devices, magnetic devices such as internal hard disks and removable disks, magneto-optical disks, and all forms of nonvolatile memories including CD-ROM and DVD-ROM disks. The processor and memory may be integrated within Application-Specific Integrated Circuits (ASICs) or added by ASICs.

While the present invention has been described on the basis of a series of functional blocks, it is not limited by the embodiments described above and the accompanying drawings, and it will be apparent to those skilled in the art that various substitutions, modifications and variations can be made without departing from the scope of the present invention.

The combination of the above-described embodiments is not limited to the above-described embodiments, and various forms of combination in addition to the above-described embodiments may be provided according to implementation and/or necessity.

In the above-described embodiments, the methods are described on the basis of a flowchart as a series of operations or blocks, but the present invention is not limited to the order of the operations, and some operations may occur in different orders or at the same time unlike those described above. It will also be understood by those skilled in the art that the operations shown in the flowchart are not exclusive, and other operations may be included, or one or more operations in the flowchart may be omitted without affecting the scope of the present invention.

The above-described embodiments include examples of various aspects. While it is not possible to describe every possible combination for expressing various aspects, one of ordinary skill in the art will recognize that other combinations are possible. Accordingly, it is intended that the present invention include all alternatives, modifications and variations that fall within the scope of the following claims.

What is claimed is:

1. A method for controlling power supply to a heating, ventilating, and air-conditioning (HVAC) system for a building based on a target temperature, wherein the method comprises:
generating a zone-based temperature prediction model by training an artificial neural network based on a plurality of first training data, wherein the zone-based temperature prediction model is configured to receive a building indoor temperature, a supplied power and building environment information at a plurality of time-points prior to a prediction timing and having a first time interval, and to predict a building indoor temperature at the prediction timing; and
determining a sequence of optimal to-be-supplied powers at one or more time-points after a current time-point, wherein the sequence of optimal to-be-supplied powers allows minimizing a value of a loss function associated with a difference between a sequence of predetermined target temperatures and a sequence of predicted temperatures predicted based on the zone-based temperature prediction model, at said one or more time-points after the current time-point and having the first time interval.

2. The method of claim 1, wherein the building has a plurality of zones,
wherein at least one of the indoor temperature, the building environment information, the target temperature and the predicted temperature is determined for each of the plurality of zones.

3. The method of claim 2, wherein each of the plurality of first training data comprises:
a previous building indoor temperature, a previous supplied power and a previous building environment information, and a current building indoor temperature for each of the plurality of zones based on the previous building indoor temperature, and the previous supplied power and the previous building environment information.

4. The method of claim 2, wherein the building environment information comprises: at least one of an adjacent-zone temperature, an ambient temperature around the building, a cooling rate of the HVAC system, a thermal gain from a convective load in a zone, and a thermal gain from a radiative load in a zone.

5. The method of claim 2, wherein a value of the loss function is determined based on a sum of values associated with a difference between a sequence of predetermined target temperatures and a sequence of predicted temperatures predicted based on the zone-based temperature prediction model for each of the plurality of zones.

6. The method of claim 5, wherein the value of the loss function is computed by adding a weight to a difference between the target temperature and the predicted temperature in at least one zone of the plurality of zones, wherein the at least one zone accommodates therein an occupant with a high temperature sensitivity.

7. The method of claim 1, wherein the artificial neural network comprises a recurrent neural network (RNN).

8. The method of claim 1, wherein the artificial neural network comprises a Long Short Term Memory (LSTM).

9. The method of claim 1, wherein a value of the loss function is determined based on a sum of differences between target temperatures included in a sequence of the predetermined target temperatures and predicted temperatures at time-points corresponding to the target temperatures respectively.

10. The method of claim 1, wherein determining the sequence of optimal to-be-supplied powers comprises:
initializing optimal to-be-supplied powers included in the sequence of the optimal to-be-supplied powers and at each of one or more time-points having the first time interval;
determining a first optimal to-be-supplied power at a first time-point of said one or more time-points having the first time interval, wherein the first optimal to-be-supplied power allows minimizing a value of the loss function; and
determining a second optimal to-be-supplied power at a second time-point after the first time-point, wherein the second optimal to-be-supplied power allows minimizing a value of the loss function computed when the optimal to-be-supplied power is updated to first optimal to-be-supplied power at the first time-point.

11. The method of claim 10, wherein initializing the optimal to-be-supplied powers comprises initializing the optimal to-be-supplied powers based on a K-Nearest Neighbor (KNN) scheme.

12. The method of claim 11, wherein initializing the optimal to-be-supplied powers comprises initializing the optimal to-be-supplied powers based on an average of K nearest input powers determined based on a Euclidean distance to the target temperature.

13. The method of claim 10, wherein determining the first optimal to-be-supplied power and determining the second optimal to-be-supplied power comprises, respectively, determining the first optimal to-be-supplied power and determining the second optimal to-be-supplied power based on a stochastic gradient descent (SGD) scheme performed over nᵢₜe times iterations.

14. The method of claim 10, wherein in determining the first optimal to-be-supplied power and determining the second optimal to-be-supplied power, only variables for the supplied power in the zone-based temperature prediction model from the artificial neural network are variable while remaining variables are fixed.

15. A device for controlling power supply to a heating, ventilating, and air-conditioning (HVAC) system for a building based on a target temperature, wherein the device comprises a memory and a processor connected to the memory, wherein the processor is configured for:
generating a zone-based temperature prediction model by training an artificial neural network based on a plurality of first training data, wherein the zone-based temperature prediction model is configured to receive a building indoor temperature, a supplied power and building environment information at a plurality of time-points prior to a prediction timing and having a first time interval, and to predict a building indoor temperature at the prediction timing; and
determining a sequence of optimal to-be-supplied powers at one or more time-points after a current time-point, wherein the sequence of optimal to-be-supplied powers allows minimizing a value of a loss function associated with a difference between a sequence of predetermined target temperatures and a sequence of predicted temperatures predicted based on the zone-based temperature prediction model, at said one or more time-points after the current time-point and having the first time interval.

16. The device of claim 15, wherein the building has a plurality of zones,
wherein at least one of the indoor temperature, the building environment information,
the target temperature and the predicted temperature is determined for each of the plurality of zones.

17. The device of claim 15, wherein determining the sequence of optimal to-be-supplied powers comprises:
initializing optimal to-be-supplied powers included in the sequence of the optimal to-be-supplied powers and at each of one or more time-points having the first time interval;
determining a first optimal to-be-supplied power at a first time-point of said one or more time-points having the first time interval, wherein the first optimal to-be-supplied power allows minimizing a value of the loss function; and
determining a second optimal to-be-supplied power at a second time-point after the first time-point, wherein the second optimal to-be-supplied power allows minimizing a value of the loss function computed when the optimal to-be-supplied power is updated to first optimal to-be-supplied power at the first time-point.

18. A computer readable storage medium having instructions, wherein when executed by a processor, the instructions allow the processor to control power supply to a heating, ventilating, and air-conditioning (HVAC) system for a building based on a target temperature, wherein when executed by the processor, the instructions allow the processor to:
generate a zone-based temperature prediction model by training an artificial neural network based on a plurality of first training data, wherein the zone-based temperature prediction model is configured to receive a building indoor temperature, a supplied power and building environment information at a plurality of time-points prior to a prediction timing and having a first time interval, and to predict a building indoor temperature at the prediction timing; and
determine a sequence of optimal to-be-supplied powers at one or more time-points after a current time-point, wherein the sequence of optimal to-be-supplied powers allows minimizing a value of a loss function associated with a difference between a sequence of predetermined target temperatures and a sequence of predicted temperatures predicted based on the zone-based temperature prediction model, at said one or more time-points after the current time-point and having the first time interval.
